(19) United States
(12) Patent Application Publication
(10) Pub. No.: US 2016/0005316 A1
(43) Pub. Date: Jan. 7, 2016

(54) AROUND VIEW SYSTEM AND OPERATING METHOD THEREOF

(71) Applicant: Hyundai Mobis Co., Ltd., Seoul (KR)

(72) Inventor: Seong soo LEE, Yongin-si (KR)

(21) Appl. No.: 14/789,220

(22) Filed: Jul. 1, 2015

(30) Foreign Application Priority Data
Jul. 2, 2014 (KR) 10-2014-0082584

(51) Int. Cl. G08G 1/14; H04N 5/247; G06K 9/46; G06T 5/50; G06K 9/00; H04N 7/18; H04N 5/232

(52) U.S. Cl. CPC G08G 1/14; H04N 7/181; H04N 5/247; H04N 5/23238; G06T 5/50; G06K 9/00812; G06K 9/4604; G06T 2207/10016; G06T 2207/30264

(57) ABSTRACT

An around view system includes: a camera module configured to photograph surrounding images of a vehicle; a control module configured to output an around view monitoring (AVM) combined image obtained by combining the surrounding images according to a setting reference; and a display module configured to display the AVM combined image, in which the control module includes: a generating unit configured to generate an AVM image, in which a view of the surrounding image is converted; a recognizing unit configured to recognize a parking line and a section corner crossing the parking line in the AVM image; and a control unit configured to set a virtual parking section based on the parking line and the section corner, and output the AVM combined image obtained by combining the AVM image and the virtual parking section according to the reference setting.

### CROSS REFERENCE TO RELATED APPLICATION

This application claims priority from and the benefit of Korean Patent Application No. 10-2014-0082584 filed Jul. 2, 2014, which is hereby incorporated by reference for all purposes as if fully set forth herein.

### BACKGROUND

1. Field

Exemplary embodiments relate to an around view system and an operating method thereof. More particularly, exemplary embodiments relate to an around view system, which enables a user to easily recognize a parking section while the user parks a vehicle, and an operating method thereof.

2. Discussion of the Background

A vehicle has been a necessity of modern society for a long time. As vehicles are the main and representative transportation means in modern life, the number of vehicles is rapidly increasing. In response, an automatic parking system has been developed in order to help drivers park their vehicles.

An automatic parking system first determines whether parking is available by scanning for a parking space using an ultrasonic sensor mounted in a vehicle and then checking for obstacles located in a corresponding region. However, this has a disadvantage in that the direction of a target parking position may be misaligned relative to the position of a previously parked vehicle, and the boundary of the vehicles parked on the left and right sides cannot be precisely recognized with an ultrasonic sensor having a predetermined beam width. Accordingly, the success rate of identifying a target parking position may be suboptimal.

A parking assistant system using an ultrasonic sensor executes parking control based on the position and direction of objects that exist in the space searched, so that when there are no parked vehicles, it is impossible to set a parking reference. Thus, it is difficult to provide the automatic parking assistant function.

Recently, research for applying an around view system to photograph areas surrounding a vehicle through a camera module mounted in the vehicle has been conducted. The around view system is able to recognize a parking section, including a parking section in which a curb or a parking section line does not exist, from the photographs.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an around view system, which enables a user to easily recognize a parking section while the user parks a vehicle, and an operating method thereof.

Additional aspects will be set forth in the detailed description which follows, and, in part, will be apparent from the disclosure, or may be learned by practice of the inventive concept.

According to exemplary embodiments, the present disclosure provides an around view system, including: a camera module configured to photograph images surrounding the vehicle; a control module configured to output an around view monitoring (AVM) combined image obtained by combining the surrounding images according to a reference setting; and a display module configured to display the AVM combined image. The control module includes: a generating unit configured to generate an AVM image, in which a view of the surrounding image is converted; a recognizing unit configured to recognize a parking line and a section corner crossing the parking line in the AVM image; and a control unit configured to set a virtual parking section based on the parking line and the section corner, and output the AVM combined image obtained by combining the AVM image and the virtual parking section according to the reference setting.

Another exemplary embodiment of the present disclosure provides a method of operating an around view system, including: photographing images surrounding vehicle; generating an around view monitoring (AVM) image, in which a view of the surrounding image is converted; recognizing a parking line in the AVM image; recognizing a section corner crossing the parking line in the AVM image; and setting a virtual parking section based on the parking line and the section corner; and outputting an AVM combined image obtained by combining the AVM image and the virtual parking section according to a predetermined reference.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a control block diagram illustrating a control configuration of an around view system according to exemplary embodiments.

FIG. 2 is a control block diagram illustrating a control configuration of the control module illustrated in FIG. 1.

FIG. 3 is a diagram illustrating an example of recognition of a parking line according to exemplary embodiments.

FIG. 4 is a diagram illustrating an example of recognition of a section corner according to exemplary embodiments.

FIG. 5 is a flowchart illustrating an operating method of the around view system according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

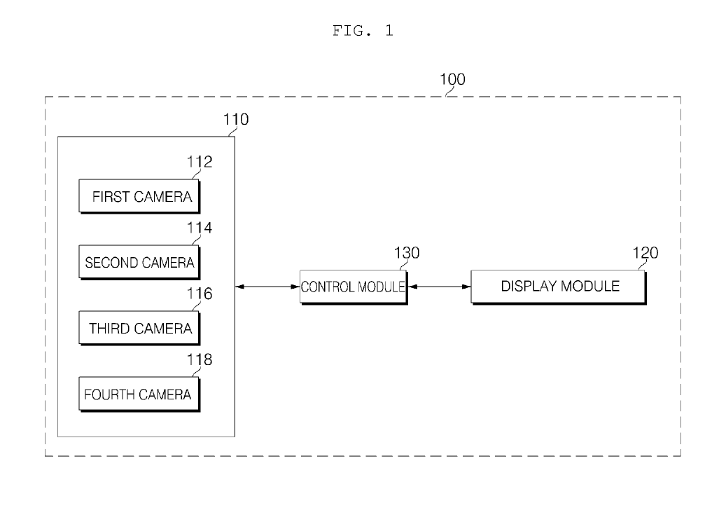

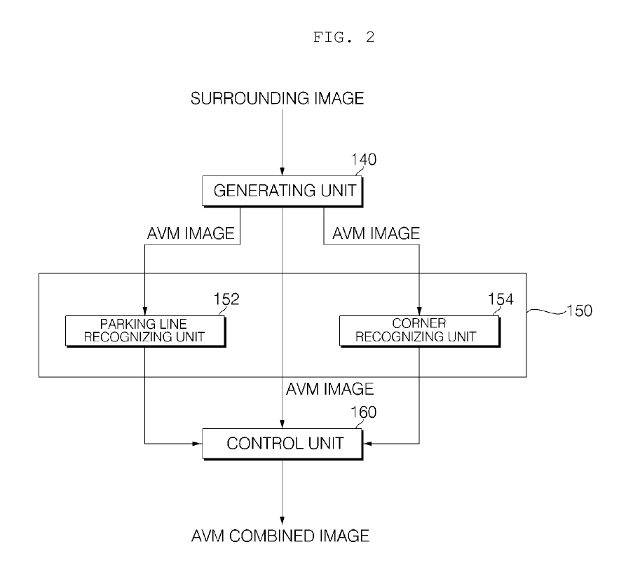

Referring to FIGS. 1 and 2, the around view system 100 may include a camera module 110, a display module 120, and a control module 130.

The camera module 110 may include a plurality of cameras photographing surrounding images of a vehicle. For example, as illustrated in FIG. 1, the camera module 110 may include a first camera 112, a second camera 114, a third camera 116, and a fourth camera 118. The cameras 112, 114, 116, and 118 may photograph all or some part of the front, rear, and sides of the vehicle.

In an exemplary embodiment, it is described that the camera module 110 includes four cameras, 112, 114, 116, and 118, but the camera module 110 may include, for example, only the second camera 114 photographing a rear image of the vehicle, and thus, the number of cameras is not limited.

In an exemplary embodiment, it is described and illustrated in the drawing that each of the first to fourth cameras 112, 114, 116, and 118 transmits a photographed image to the control module 130. Exemplary embodiments may include, for example, a camera control unit (not illustrated) for combining images photographed by the first to fourth cameras 112, 114, 116, and 118, generating a surrounding image, and transmitting the generated surrounding image to the control module 130, but exemplary embodiments are not limited thereto.

The display module 120 may display an around view monitoring (AVM) combined image received from the control module 130. The display module 120 may include a touch display panel, through which a user may input a touch, but is not limited thereto.

The control module 130 may collect travel information about the vehicle including, but not limited to, one or more among speed and gear position of the vehicle from a plurality of sensors (not illustrated) installed in the vehicle.

In this case, the control module 130 may control some or all of the cameras to be individually turned on or turned off according to the travel information collected by the plurality of sensors. For example, when the gear position corresponds to a mode in which the vehicle moves forward, the control module 130 may turn on one or more cameras to receive a front image. In another example, when the gear position corresponds to a mode in which the vehicle is driven in reverse, the control module 130 may turn on one or more cameras to receive a rear image. The control module 130 may also control one or more cameras to be always turned on regardless of the travel information collected by the plurality of sensors.

The control module 130 may control the cameras 112, 114, 116, and 118, so as to generate an AVM combined image obtained by combining the surrounding images photographed by one or more cameras 112, 114, 116, and 118 according to a predetermined reference or by combining an AVM image and a virtual parking section, and display the generated AVM combined image on the display module 120.

As illustrated in FIG. 2, the control module 130 may include a generating unit 140, a recognizing unit 150, and a control unit 160.

The generating unit 140 may generate an AVM image, in which a view of the surrounding image is converted. That is, the generating unit 140 converts the images photographed by the cameras according to a predetermined conversion ratio and generates the AVM image. For example, the generating unit 140 may convert the front image so as to obtain an image as if a front region of the vehicle is viewed from an elevated point of view by applying a predetermined first conversion ratio to the front image received from one or more cameras.

The generating unit 140 may convert the views of the rear image, the left-side image, and the right-side image by applying second to fourth conversion ratios to one or more cameras.

Accordingly, the generating unit 140 may generate the AVM image by combining some or all of the front image, the rear image, the left-side image, and the right-side image.

The recognizing unit 150 may recognize a parking line and a section corner in the AVM image. Here, the section corner refers to a corner crossing the parking line among the corners in the AVM image. Particularly, the recognizing unit 150 may recognize a parking line based on a plurality of parking characteristic points extracted from the AVM image, and may recognize a section corner crossing the parking line based on the plurality of corner characteristic points extracted from the AVM image.

The recognizing unit 150 may include a parking line recognizing unit 152 and a corner recognizing unit 154.

The parking line recognizing unit 152 may extract the plurality of parking characteristic points satisfying a predetermined parking line pattern in the AVM image, and may recognize the parking line by applying a line-fitting algorithm to the plurality of parking characteristic points. The parking line pattern may be a brightness pattern of the predetermined parking line.

The corner recognizing unit 154 may extract the plurality of corner characteristic points by applying a corner detection algorithm to the AVM image, and may recognize the section corner based on the parking line and the plurality of corner characteristic points. For example, the corner recognizing unit 154 may extract the plurality of corner characteristic points by applying the Harris corner algorithm or other corner detecting algorithm, and the like to the AVM image.

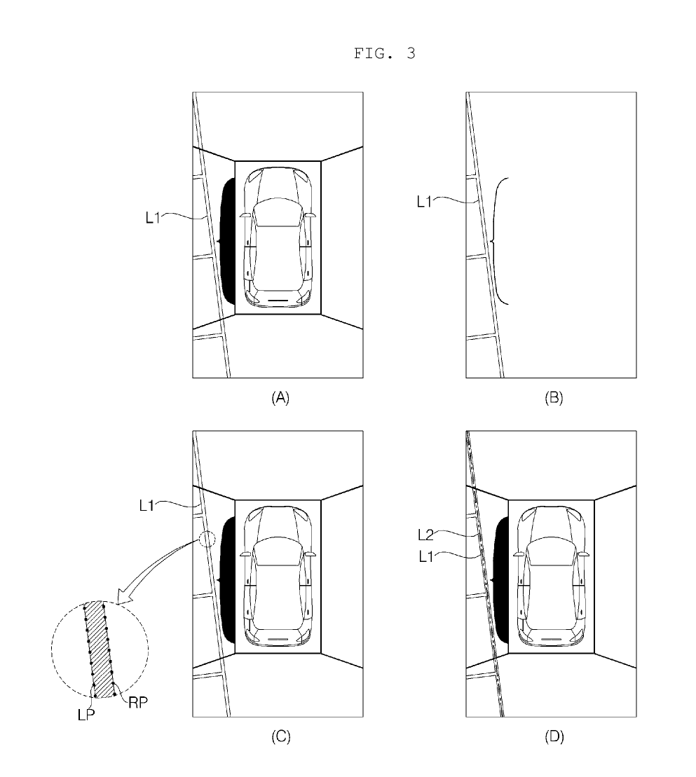

Here, operation of the parking line recognizing unit 152 will be described in detail with reference to FIG. 3.

As illustrated in FIG. 3A, in order to recognize a parking line L1 in the AVM image, the parking line recognizing unit 152 may generate a contour line image including an edge corresponding to the parking line L1 included in the AVM image by using a brightness pattern of a predetermined parking line as illustrated in FIG. 3B.

The parking line recognizing unit 152 extracts a plurality of parking characteristic points LP and RP from the AVM image by recognizing a point at which brightness of the parking line L1 is sharply changed in the contour line image, as illustrated in FIG. 3C. For example, the plurality of parking characteristic points LP and RP may be points at which a brightness change in a horizontal direction within the contour line image is equal to or larger than a predetermined reference value.

Then, the parking line recognizing unit 152 may recognize the parking line L2 or a virtual parking line by connecting the plurality of parking characteristic points LP and RP to each other according to the line-fitting algorithm, as illustrated in FIG. 3D. For example, the parking line recognizing unit 152 may recognize a straight line satisfying the predetermined parking line pattern among the straight lines generated according to the connection of the plurality of parking characteristic points LP and RP according to the line fitting algorithm as the parking line L2. Here, the parking line L2 recognized by the parking line recognizing unit 152 may correspond to the parking line L1 in the AVM image.

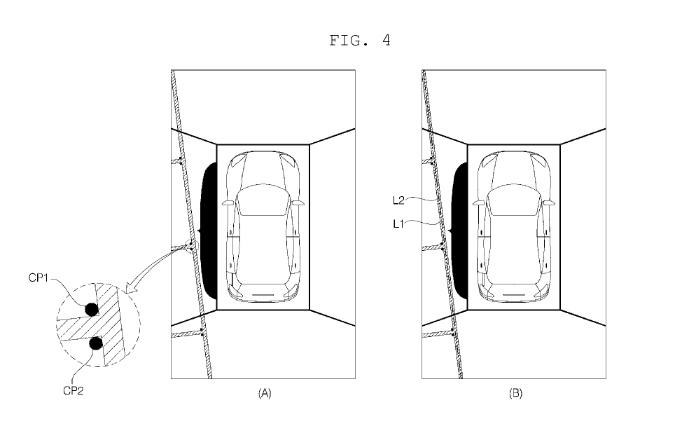

Next, an operation of the corner recognizing unit 154 will be described in detail with reference to FIG. 4.

The corner recognizing unit 154 may extract a corner pattern in the AVM image according to the corner detection algorithm, such as the Harris corner algorithm, as illustrated in FIG. 4A. Further, the corner recognizing unit 154 may extract a plurality of corner characteristic points CP1 and CP2 based on the corner pattern. For example, when the corner pattern has a “T” shape, the corner characteristic points CP1 and CP2 may cross points of two orthogonal straight lines in the T-shaped corner pattern as illustrated in FIG. 4A.

In FIG. 4A, only the T-shaped corner pattern is illustrated, but the corner pattern may have, for example, a “ [symbol] ” shape, and thus, a shape of the corner pattern is not limited.

As illustrated in FIG. 4B, the corner recognizing unit 154 may recognize the section corner according to whether the plurality of corner characteristic points CP1 and CP2 extracted in FIG. 4A crosses the parking line L2 recognized in FIG. 3D. For example, the corner recognizing unit 154 may recognize the points at which the plurality of corner characteristic points CP1 and CP2 cross the parking line L2 as the section corner.

The control unit 160 may control the display module 120 to display the AVM combined image obtained by combining or overlapping the parking line L2 and the section corner recognized by the parking line recognizing unit 152 and the corner recognizing unit 154.

The control unit 160 may generate a virtual parking section by connecting the parking line L and the section corner to each other. Further, the control unit 160 may control the display module 120 so that the virtual parking section is displayed, but is not limited thereto.

Although not shown in the exemplary embodiment, the control unit 160 may recognize that the parking line L1 is disconnected or irregularly formed. The irregularly formed parking line L1 may be represented in the AVM image, for example, at a time when the vehicle moves to an area around a curb. The control unit 160 may substitute the recognized parking line L1 for the previously recognized parking line L2 and may confirm the corner section in the parking line L1 irregularly formed around the curb, thereby improving convenience for a user.

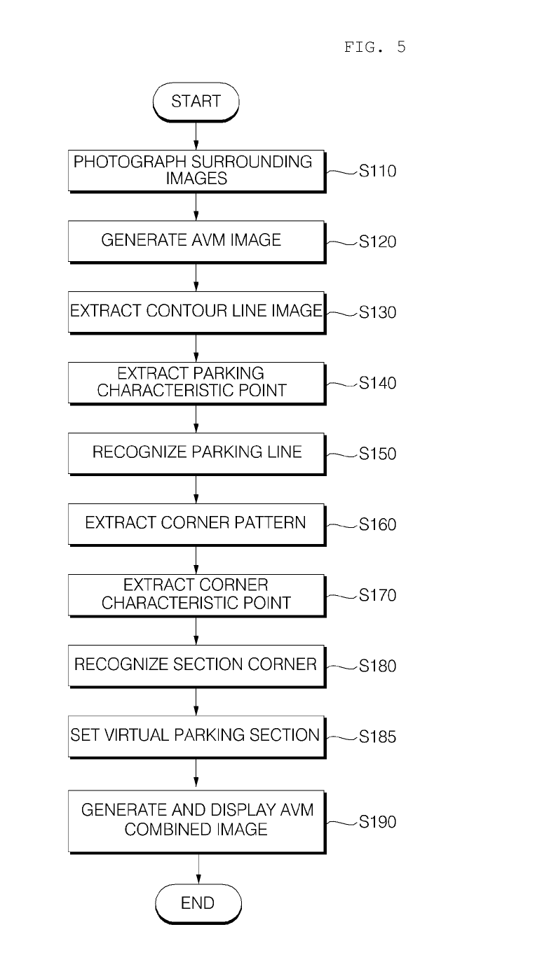

FIG. 5 is a flowchart illustrating an operating method of the around view system 100 according to the present disclosure.

Referring to FIG. 5, the control module 130 of the around view system 100 photographs a surrounding image of the vehicle by operating the camera module 110 (S 110). That is, the camera module 130 may receive surrounding images of the vehicle, that is, photographed images surrounding the vehicle, by operating the camera module 120 including one or more of the first camera 112, the second camera 114, the third camera 116, and the fourth camera 118.

Next, the control module 130 generates an AVM image, in which a view of the surrounding image is converted (S 120), and extracts a contour line image from the AVM image based on at least one of brightness and color (S 130). For example, the control module 130 may extract the contour image by designating brightness of black and white of each pixel of the AVM image.

The control module 130 extracts the plurality of parking characteristic points satisfying the parking line pattern in the contour line image (S 140), and may recognize a parking line by connecting the plurality of parking characteristic points according to the line fitting algorithm (S 150).

The control module 130 extracts a corner pattern in the AVM image by using the corner detection algorithm (S 160).

The control module 130 extracts a plurality of corner characteristic points based on the corner pattern (S 170), and may recognize the section corner according to whether the parking line L2 crosses the plurality of corner characteristic points (S 180).

The control module 130 sets a virtual parking section based on the parking line L2 and the section corner (S 185), and controls the display module 120 so that an AVM combined image obtained by combining the AVM image and the virtual parking section according to a setting reference is displayed (S 190).

According to the around view system and the operating method thereof according to the present disclosure, it is possible to display an AVM combined image obtained by combining an AVM image and a virtual parking section based on surrounding images of a vehicle in an area around a curb or a parking space, in which a parking section line does not exist, thereby enabling a user to confirm a parking space for the vehicle.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An around view system, comprising:
a camera module configured to capture images of an area surrounding a vehicle;
a control module configured to output an around view monitoring (AVM) combined image obtained by combining the surrounding images according to a reference setting; and
a display module configured to display the AVM combined image,
wherein the control module comprises:
a generating unit configured to generate an AVM image, in which a view of the surrounding image is converted;
a recognizing unit configured to recognize a parking line and a section corner crossing the parking line in the AVM image; and
a control unit configured to set a virtual parking section based on the parking line and the section corner and output the AVM combined image obtained by combining the AVM image and the virtual parking section according to the setting reference.

2. The around view system of claim 1, wherein the camera module comprises cameras configured to photograph and capture images of the areas surrounding the vehicle.

3. The around view system of claim 2, wherein the areas surrounding the vehicle comprise a front, a rear, a left-side, and a right-side.

4. The around view system of claim 1, wherein the recognizing unit comprises:
a parking line recognizing unit configured to extract parking characteristic points satisfying a reference parking line pattern from the AVM image and recognize the parking line by applying a line fitting algorithm to the parking characteristic points; and
a corner recognizing unit configured to extract corner characteristic points by applying a corner detecting algorithm to the AVM image and recognize the section corner based on the parking line and the corner characteristic points.

5. The around view system of claim 4, wherein the corner detecting algorithm comprises a Harris corner detecting algorithm.

6. The around view system of claim 3, wherein the parking line pattern is a brightness pattern of a reference parking line.

7. The around view system of claim 3, wherein the parking line recognizing unit extracts a contour line image from the AVM image based on at least one of brightness and color, and extracts the plurality of parking characteristic points satisfying the parking line pattern from the contour line image.

8. The around view system of claim 5, wherein the parking line recognizing unit recognizes the parking line by connecting the parking characteristic points to each other according to the line fitting algorithm.

9. The around view system of claim 3, wherein the corner recognizing unit extracts a corner pattern from the AVM image according to a corner detecting algorithm, and extracts the corner characteristic points based on the corner pattern.

10. The around view system of claim 7, wherein the corner recognizing unit recognizes cross points of the parking line and the corner characteristic points as the section corner.

11. The around view system of claim 1, wherein the control unit sets the virtual parking section by connecting the parking line and the section corner to each other.

12. A method of operating an around view system, comprising:
capturing images of an area surrounding a vehicle;
generating an around view monitoring (AVM) image, in which a view of the surrounding image is converted;
recognizing a parking line in the AVM image;
recognizing a section corner crossing the parking line in the AVM image;
setting a virtual parking section based on the parking line and the section corner; and
outputting an AVM combined image obtained by combining the AVM image and the virtual parking section according to a reference.

13. The method of claim 12, further comprising:
displaying the AVM combined image.

14. The method of claim 12, wherein the recognizing of the parking line comprises:
extracting a contour line image in the AVM image based on at least one of brightness and a color, and extracting the plurality of parking characteristic points satisfying a predetermined parking line pattern in the contour line image; and
recognizing the parking line by connecting the plurality of parking characteristic points to each other according to a line fitting algorithm.

15. The method of claim 12, wherein the recognizing of the corner comprises:
extracting a corner pattern in the AVM image according to a corner detecting algorithm, and extracting the plurality of corner characteristic points based on the corner pattern; and
recognizing cross points of the parking line and the plurality of corner characteristic points as the section corner.
